(19) United States
(12) Patent Application Publication
(10) Pub. No.: US 2012/0194804 A1
(43) Pub. Date: Aug. 2, 2012

(54) SEMICONDUCTOR LASER BASED INTRA-CAVITY OPTICAL MICRO-FLUIDIC BIOSENSOR

(75) Inventors: Jian-Jun He, Hangzhou (CN); Tingting Yu, Hangzhou (CN); Min Lou, Hangzhou (CN)

(73) Assignee: ZHEJIANG UNIVERSITY, Hangzhou (CN)

(21) Appl. No.: 13/496,886

(22) PCT Filed: Oct. 14, 2010
(86) PCT No.: PCT/CN10/77730

§ 371 Date: Mar. 19, 2012

(30) Foreign Application Priority Data
Oct. 19, 2009 (CN) 200910153378.4

(51) Int. Cl. G01N 21/41

(52) U.S. Cl. 356/128

(57) ABSTRACT

A semiconductor laser based intra-cavity optical micro-fluidic biosensor comprises a coupled-cavity semiconductor laser, a 2×2 coupler and a phase adjustment section on one input port of the coupler. The dominant mode of the coupled-cavity laser appears in one output port of the coupler, while the adjacent mode comes out from the other output port of the coupler. The resonant frequency interval of the sensing cavity is slightly larger or smaller than one half of that of the reference cavity. Part of the sensing cavity is the sensing section which is covered by an analyte. The refractive index change of the analyte will cause the lasing mode of the coupled cavity to switch to an adjacent mode, resulting in a π-phase change in the phase difference between the two output ports of the two resonance cavities. By applying the Vernier effect, the power ratio of the two output ports of the coupler will change and the refractive index change of the analyte can be derived. A detection limit of 10⁻⁸ RIU or smaller can be achieved.

### FIELD OF THE INVENTION

This invention relates generally to a biosensor, more particularly to an intra-cavity optical micro-fluidic biosensor based on a monolithically integrated semiconductor laser.

### BACKGROUND OF THE INVENTION

Biochemical detection and environmental monitoring has become another important application field for integrated optoelectronic devices after the great success of optical communication. Optical biosensors have attracted considerable attention because of their immunity to electromagnetic interference, noninvasive detection, shorter response time and higher sensitivities, and in particular, because they are the only technology that allows the direct detection of biomolecular reactions. Integrated optical biosensors enable the analysis instruments to develop towards high integration density, high sensitivity and high compactness, and also make it possible for simultaneous detection of multiple parameters on a monolithic integrated biosensor array. In addition, integrated optical biosensors have the advantages such as high stability, high reliability, low power consumption, reduced requirement for alignment, and lower cost because of its potential for mass production.

In a survey of commercial optical biosensor literature, it was pointed out that each year nearly 1000 articles were published on different commercially available optical biosensor technologies, while various types of sensors with high sensitivity are emerging. Most of the optical bio-sensors are passive optical structures based on detection of refractive index change, such as Surface Plasmon Resonance (SPR) structures, interference structure (e.g., Mach-Zehnder interferometer, Young's interference structures), anti-resonant waveguide structures, hollow waveguide structures, Bragg gratings, slotted waveguide based on silicon-on-insulator (SOI), integrated optical micro-resonators (micro-ring resonators), nano-fiber ring structures, and so on. These widely reported sensors all need an additional external light source or a spectrometer to analyze the sensing characteristics, which greatly increased the operation difficulty and cost.

In the article “Surface plasmon interferometer in silicon-on-insulator: novel concept for an integrated biosensor”, an integrated surface plasmon interferometer based on SOI is proposed by Peter Debackere, Stijn Scheerlinck, Peter Bienstman and Roel Baets, as shown in FIG. 1(a). The device is based on SOI technology consisting of a 60 nm gold layer embedded in a silicon membrane. The high degree of asymmetry associated with the gold layer (top interface sample about 1.33, bottom interface 3.45) assures that the surface plasmon modes associated with the upper and lower of the metal-dielectric interfaces will never be able to couple because their wave vectors differ too much. Consequently this device can be considered as an interferometer. The phase of the top surface plasmon mode is influenced by the refractive index of the analyte sample. At the end of the gold layer both surface plasmon modes excite the fundamental mode of the SOI waveguide. Depending on the relative phase of the surface plasmon modes, their contributions to the ground mode will interfere constructively or destructively. Under intensity detection accuracy of 0.01 dB, the sensor has a refractive index detection limit as small as 10⁻⁶.

Biosensors based on Mach Zehnder interferometer (MZI) structures have also been extensively studied. For example, in the article “An integrated optical interferometric nanodevice based on silicon technology for biosensor applications”, Nanotechnology 14 907-912, 2003, Prieto et al proposed an integrated optical biosensor based on silicon technology for environmental monitoring and medical applications. As shown in FIG. 1(b), the single mode waveguide structure has been designed with a Si₃N₄ core layer of 250 nm thick, a rib depth and width of 4 μm, over an SiO₂ cladding layer of 2 μm thick. The length of sensing area is 15 mm. By detecting the output phase affected by the analyte through evanescent wave, one can obtain the change in the concentration or refractive index of the analyte in the sensing area. The detection limit can reach 7×10⁻⁶ in refractive index unit. However, the passive biosensor needs to introduce external light source excitation, which increases the operation difficulty. Besides, the detection limit still has a large room for improvement.

Not much research has been devoted to active optical biosensor with integrated light source. D. Kumar, H. Shao, and K. L. Lear proposed a microfluidic vertical cavity laser biosensor in “Vertical Cavity Laser and Passive Fabry Perot Interferometer Based Microfluidic Biosensors”, as shown in FIG. 2 where 13 is the electrode, 14 is the top Distributed Bragg Reflector (with reflectivity of 99.9%), 15 is the bottom DBR (with reflectivity of 75%-80%), 16 is biological samples in the microfluidic cavity, 17 is the microfluidic channel. The optofluidic channel is integrated near the bottom reflector. The sensitivity of the structure is limited because the length of the cavity with microfluidic channel is very small.

### SUMMARY OF THE INVENTION

The purpose of this invention is to provide a semiconductor laser based intra-cavity optical micro-fluidic biosensor to overcome the deficiencies of the prior arts.

In accordance with the present invention, there is provided, a semiconductor laser based intra-cavity optical micro-fluidic biosensor comprising

a coupled-cavity semiconductor laser consisting of a reference cavity and a sensing cavity that are coupled to each other, a 2×2 coupler, and a phase adjustment section on either input port of the 2×2 coupler,

said reference cavity and sensing cavity are coupled to each other through a coupler to exchange energy, with the resonant frequencies of said reference cavity corresponding to a series of equally spaced operation frequencies, and the resonant frequency interval of said sensing cavity is different from that of said reference cavity so that at most only one resonant frequency of said sensing cavity coincides with one of the resonant frequencies of said reference cavity over the material gain window of the laser,

said sensing cavity contains a sensing section which is totally or partially in contact with an analyte,

whereas the outputs from the reference cavity and the sensing cavity are coupled through the input ports to the output ports of the 2×2 coupler, after passing through the phase adjustment section.

In accordance with the present invention, there is further provided, a semiconductor laser based intra-cavity optical micro-fluidic biosensor as defined above,

wherein the resonant frequency interval of the sensing cavity is 0.4-0.6 times that of the reference cavity so that when the refractive index change of the analyte causes the lasing mode of the coupled cavity laser to switch from one mode to its adjacent mode, the phase difference of the laser output fields at the cleaved facets or etched trenches will experience a π-phase change,

said reference cavity and the sensing cavity are Fabry-Perot cavities formed by etched trenches as the partially reflecting mirrors on both sides, which constitute a V-shaped coupled cavity,

said reference cavity and the sensing cavity are Fabry-Perot cavities formed by etched trenches as the partially reflection mirrors on both sides with a common waveguide section, which constitute a Y-shaped coupled cavity,

said reference cavity and the sensing cavity are micro-ring resonators,

said one of the reference cavity and the sensing cavity is a Fabry-Perot cavity and the other is a micro-ring resonator.

Compared with the prior arts, the present invention provides the following benefits:
1. The quality factor of the output spectrum of the laser is much greater than that of passive structures, thus the sensor has much higher sensitivity.
2. The monolithically integrated solution makes the device compact, highly integrated, suitable for mass production, and consequently low cost.
3. The active/passive integration does not require an external light source which greatly reduces the operation complexity.
4. The detection of power ratio does not require the use of expensive optical spectrum analyzer which simplifies the whole bio-sensor system.

The present invention has the potential of low-cost, high performance and versatile functionality, and may find applications in medical diagnostics biological science, drug analysis, environmental monitoring and other fields.

### BRIEF DESCRIPTION OF THE DRAWINGS

FIG. 1(a) and (b) are two examples of prior-art optical biosensors.

FIG. 2 is another prior-art optical biosensor which incorporates an optical microfluidic channel inside a VCSEL cavity.

FIG. 3 is the first implementation of the semiconductor laser based intra-cavity optical micro-fluidic biosensor of the present invention, the reference cavity 101 and the sensing cavity 102 form a V-coupled cavity.

FIG. 4 is the schematic diagram illustrating the relationship between the resonant frequencies of the two cavities and the material gain spectrum.

FIG. 5 is the threshold gain coefficient of the lowest threshold mode (solid line) and the next lowest threshold mode (dotted line) as a function of the cross coupling coefficient of the coupled cavities.

FIG. 6 is the effective reflection factors of the reference cavity 101 (solid line) and the sensing cavity 102 (dotted line) as a function of the wavelength when the laser is at the threshold.

FIG. 7 is the small signal gain spectra of the reference cavity 101 (solid line) and the sensing cavity 102 (dotted line) when the laser is near its threshold.

FIG. 8 is the lasing wavelength as a function of the refractive index change of the analyte.

FIG. 9 is the schematic showing the electrical fields at the output planes of the two cavities.

FIG. 10 is the phase difference between the electrical fields at the output planes of the two cavities as a function of sample refractive index.

FIG. 11 is the schematic showing the switching of the output power of the main lasing mode between port 3 and 4 when the phase difference between the two output planes changes from 0 to π.

FIG. 12 is the output power of different modes as a function of the refractive index change of the analyte.

FIG. 13 is the power ratio of port 4 over port 3 when the sensing cavity 102 has a resonant frequency interval of 98 GHz and the pump current is 5 times of the threshold current.

FIG. 14 is the second implementation of the present invention where the reference cavity 104 and the sensing cavity 105 form a Y-coupled cavity.

FIG. 15 is the third implementation of the present invention where the reference cavity 106 and the sensing cavity 105 are ring cavities.

FIG. 16 is the fourth implementation of the present invention where the reference cavity 108 is a Fabry-Perot cavity and the sensing cavity 109 is a ring cavity.

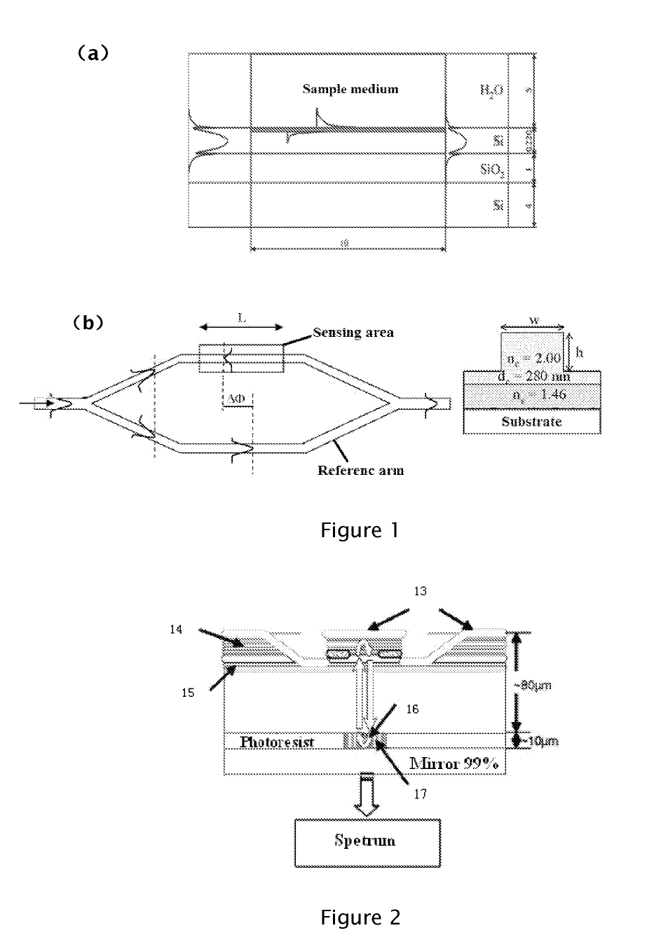

Notations used in the figures: 1. First input port of the coupler; 2. Second input port of the coupler; 3. First output port of the coupler; 4. Second output port of the coupler; 5. Phase adjustment section; 6. Partially reflecting mirror or deep etched trench; 7. Shallow etched isolation trench; 8. Partially reflecting mirror or deep etched trench; 9. 2×2 coupler; 10. Shallow etched isolation trench; 11. Coupler; 12. Partially reflecting mirror or deep etched trench; 101. Gain section of the reference cavity; 102a. Gain section of the sensing cavity; 102b. Sensing section in contact with microfluidic analyte.

### DETAILED DESCRIPTION

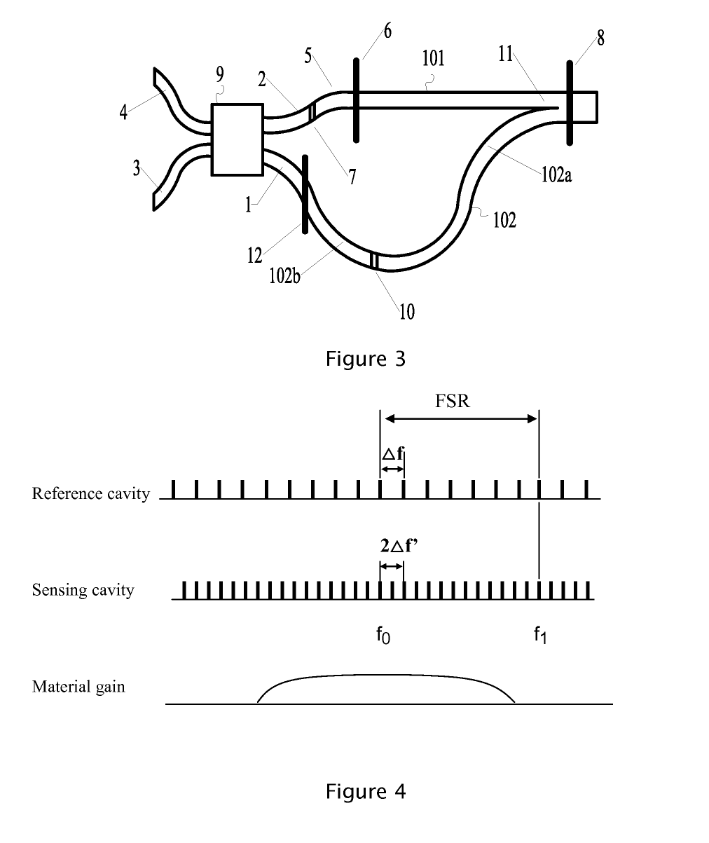

FIG. 3 is the first implementation of the present invention. The semiconductor laser based intra-cavity optical micro-fluidic biosensor comprises a reference cavity 101, a sensing cavity 102, a 2×2 coupler 9 and a phase adjustment section 5 on either input port of the 2×2 coupler. Two optical waveguide arms are placed in the reference cavity 101 and the sensing cavity 102, respectively. The two optical waveguides are very close to each other on one end (the close end), but are far away from each other on the other end (the open end). Each optical waveguide has partially reflecting mirrors on both ends, which can be a cleaved facet or rectangular deep etched trench, as indicated by elements 6, 8, 12 in FIG. 3. Each optical waveguide and the partially reflecting mirrors on both ends constitute a Fabry-Perot cavity. At least one portion of each of the waveguides in the reference cavity 101 and in the sensing cavity 102 has an electrode for injecting current to provide optical gain. The reference cavity 101 and the sensing cavity 102 are coupled to each other through the coupler 11 to exchange energy. The resonant frequencies of each of the reference cavity 101 and the sensing cavity 102 correspond to a series of equally spaced operation frequencies. The resonant frequency interval of the sensing cavity is different from that of the reference cavity so that only one resonant peak of the sensing cavity coincides with one of the resonant peaks of the reference cavity over the material gain window. A portion of the waveguide in the sensing cavity is the sensing section 102b, which is totally or partially covered by an analyte that can be introduced by a microfluidic channel. The outputs from the reference cavity and the sensing cavity are coupled through the input ports (1, 2) to the output ports (3, 4) of the 2×2 coupler (9), after passing through the phase adjustment section (5).

The resonant frequency interval of the reference cavity 101 is determined by

$$Δ f = \frac{c}{2 {n}_{g} L} \qquad ( 1 )$$

Similarly, the resonant frequency interval Δf′ of the sensing cavity is determined by:

$$Δ {f}^{′} = \frac{c}{2 {n}_{g}^{′} {L}^{′}} = \frac{c}{2 ( {n}_{a} {L}_{a} + {n}_{b} {L}_{b} )} \qquad ( 2 )$$

where c is the light velocity in vacuum, L is the waveguide length of the reference cavity, n_{g} is the effective group index of the waveguide. Lₐ, nₐ, and L_{b}, n_{b} are the waveguide length and effective group index of the gain area 102a and the sensing area 102b, respectively, in the sensing cavity. L′=Lₐ+L_{b} is the total length of the sensing cavity, n′_{g}=(nₐLₐ+n_{b}L_{b})/L′ is the averaged effective group index of the sensing cavity 102.

The optical lengths of the reference cavity 101 and the sensing cavity 102 are different so that at most only one resonant peak coincides over the material spectral gain window. When the resonant frequencies of the two cavities coincide, the laser will lase at the common resonant frequency. Since the two waveguides are close or even in contact with each other at the vicinity of the partial reflection mirror 8, a part of the light in one waveguide cavity will be coupled to the other waveguide cavity through evanescent wave coupling or optical mode field overlap. The waveguide of the sensing cavity 102 is divided into a gain section 102a and a sensing section 102b by a shallow etched isolation trench 10. The gain section 102a has an electrode for injection of current which provides optical gain. The sensing section 102b is totally or partially covered by an analyte. The effective index of the sensing section 102b will be affected by the index change of the analyte through evanescent wave. Consequently the optical path length of the sensing cavity 102 will change, affecting the emission characteristics of the laser. The analyte information can then be determined by detecting the output power and spectrum of the laser.

According to an implementation of the present invention, the frequency interval of the sensing cavity 102 is approximate half of that of the reference cavity. In such a structure, by using the Vernier effect as shown in FIG. 4, the free spectral range (FSR) is given by

$$Δ {f}_{c} = \frac{Δ f Δ {f}^{′}}{\vert Δ f - 2 Δ {f}^{′} \vert} \qquad ( 3 )$$

The FSR is designed to be larger than the spectral width of the material gain window. Since the lasing frequency is the resonant frequency of the reference cavity that coincides with one of the resonant frequencies of the sensing cavity, the frequency change of |Δf−2Δf′| by the sensing cavity results in a jump of the lasing frequency. Therefore, the change of the lasing frequency is amplified by a factor of Δf/|Δf−2Δf′|, i.e.,

$$δ f = \frac{Δ f}{\vert Δ f - 2 Δ {f}^{′} \vert} δ {f}^{′} \qquad ( 4 )$$

To analyze the threshold condition, we can consider the reference cavity 101 and the sensing cavity 102 as the main cavity separately, and the effective reflectivity of the partial reflecting mirror 6 and 12 can be written as r₂ₑ=ηr₂, r₂ₑ′=η′r₂, where η and η′ are the effective reflection factors taking into account the coupling effect between the sensing cavity 102 and the reference cavity 101, which are calculated by

$$\begin{matrix}\begin{matrix}η = {C}_{11} + {C}_{21} {C}_{12} {r}_{3} {r}_{2} {e}^{2 ( {g}^{′} + i {k}^{′} ) {L}^{′}} \\ ( 1 + {C}_{22} {r}_{3} {r}_{2} {e}^{2 ( {g}^{′} + i {k}^{′} ) {L}^{′}} + {C}_{22}^{2} {r}_{3}^{2} {r}_{2}^{2} {e}^{4 ( {g}^{′} + i {k}^{′} ) {L}^{′}} + … ) \\ = {C}_{11} + \frac{{C}_{21} {C}_{12} {r}_{3} {r}_{2} {e}^{2 ( {g}^{′} + i {k}^{′} ) {L}^{′}}}{1 - {C}_{22} {r}_{3} {r}_{2} {e}^{2 ( {g}^{′} + i {k}^{′} ) {L}^{′}}}\end{matrix} & ( 5 ) \\ \begin{matrix}{η}^{′} = {C}_{22} + {C}_{21} {C}_{12} {r}_{1} {r}_{2} {e}^{2 ( g + i k ) L} \\ ( 1 + {C}_{11} {r}_{1} {r}_{2} {e}^{2 ( g + i k ) L} + {C}_{11}^{2} {r}_{1}^{2} {r}_{2}^{2} {e}^{4 ( g + i k ) L} + … ) \\ = {C}_{22} + \frac{{C}_{21} {C}_{12} {r}_{1} {r}_{2} {e}^{2 ( g + i k ) L}}{1 - {C}_{11} {r}_{1} {r}_{2} {e}^{2 ( g + i k ) L}}\end{matrix} & ( 6 )\end{matrix}$$

From the laser threshold condition, we can obtain

C₁₁r₁r₂e^{2(g+ik)L}+C₂₂r₃r₂e^{2(g′+ik′)L′}−(C₁₁C₂₂−C₂₁C₁₂)r₁r₂²r₃e^{2(g+ik)L}e^{2(g′+ik′)L′}=1 (7)

Assume the amplitude reflectivity of the partial reflecting mirrors 6 and 8 are r₁,r₂, and that of the reflector 12 is r₃. At the coupler 11, we denote the amplitude coupling coefficients from the sensing cavity 102 to the reference cavity 101 (cross-coupling), from 101 back to 101 (self-coupling), from 102 to 101 (cross-coupling), and from 102 back to 102 (self-coupling), as C₁₂, C₁₁, C₂₁, and C₂₂, respectively. k(=2πn/λ) and g are the propagation constant and gain coefficient of the reference cavity, respectively. k′(=2πn′/λ) and g′ are the average propagation constant and average gain coefficient of the sensing cavity, respectively. L and L′ are the waveguide length of the reference cavity and the sensing cavity, respectively.

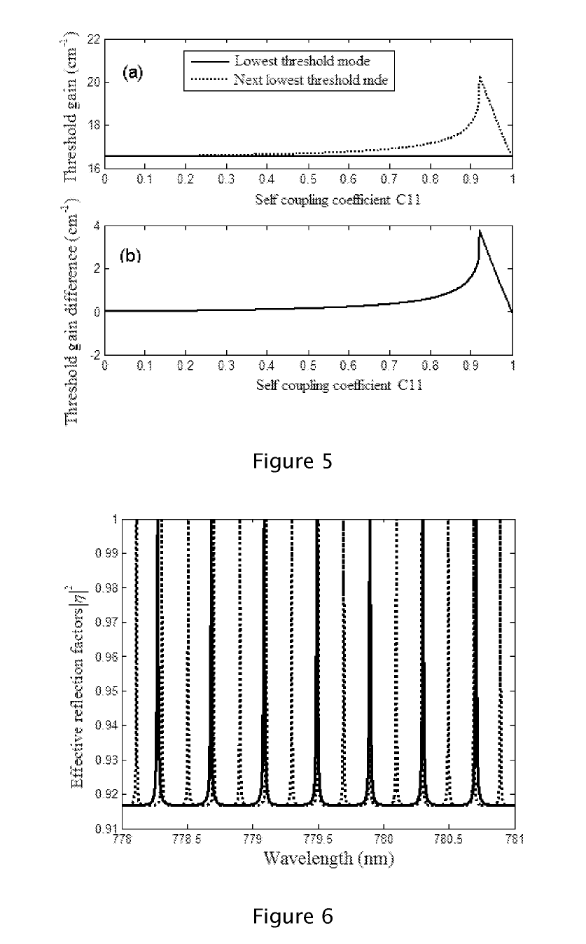

Consider an example with parameters as follows: λ₀=779.9 μm; n_{g}=3.24; nₐ=2.02; n_{b}=3.24; L=231.32 μm (Δf=200 GHz); L′=539.69 (Δf=98 GHz); Lₐ=179.9 μm. According to FIG. 5, the optimal coupling coefficients are C₁₁=C₂₂=0.92 and C₁₂=C₂,=−0.08. The two cavities have a common resonance wavelength at λ₀=779.9 μm. The partial reflecting mirrors are formed by deep etched trenches with r₁=r₂=0.826, r₃=0.591 as calculated by using the transfer matrix method. The pumping conditions can be chosen so that the two cavities have the same round trip gain, i.e., r₃r₂e^{2g′L′}=r₁r₂e^{2gL}. At the resonant peak 779.9 nm, solving Eq. (7) leads to the threshold gain coefficient of the lowest threshold mode is G₀=16.5 cm⁻¹.

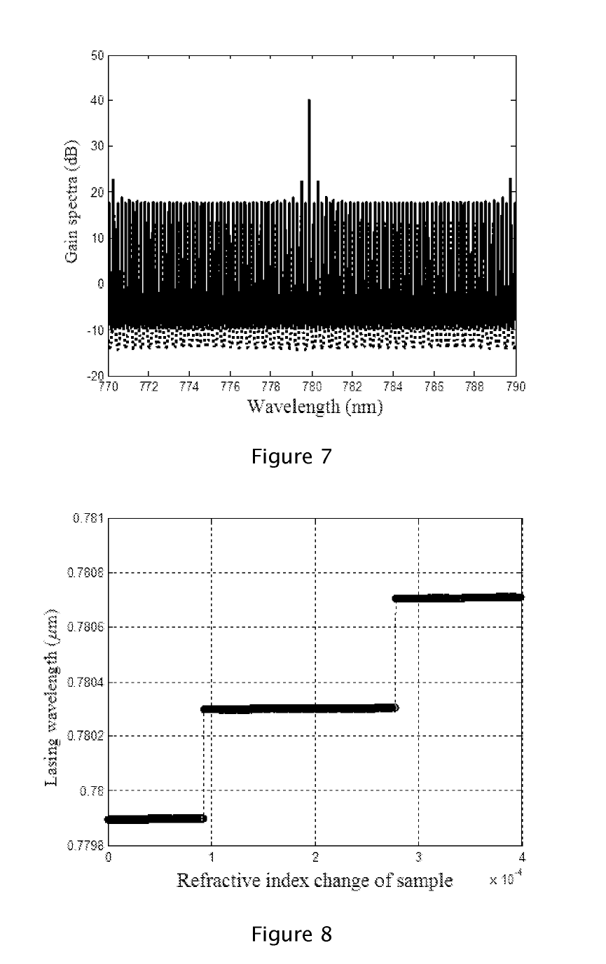

The mode selectivity and the wavelength switching function of the V-coupled cavity can be understood from the effective reflection factors η and η′ shown in FIG. 6. They are all wavelength dependent functions and form a series of resonant peaks at particular wavelengths. The wavelength at which the resonant mode of the two cavities coincides with each other is selected as the lasing mode, as shown in FIG. 7.

FIG. 8 shows the variation of the lasing wavelength when the refractive index of the analyte sample changes. The lasing wavelength variation is accompanied by power ratio variation between the main mode and the side mode (see FIG. 12). Because of the special feature, the main lasing wavelength changes discretely rather than continuously. According to the resonant condition, the optical length of the reference cavity 101 and the sensing cavity 102 must be integral multiple of half-wavelength. Since the length of the sensing cavity is approximately double of that of the reference cavity, when the main lasing mode jumps to the adjacent mode due to the change of the refractive index of the sample, the sensing cavity will shift by two mode intervals, which means a phase change of π occurs between the reflecting mirrors 8 and 6 in the reference cavity, while a phase change of 2π occurs between the reflecting mirrors 8 and 12 in the sensing cavity. Therefore, the phase difference between the output planes of the two cavities at the reflecting mirrors 6 and 12 will change from 0 to π or from π to 0.

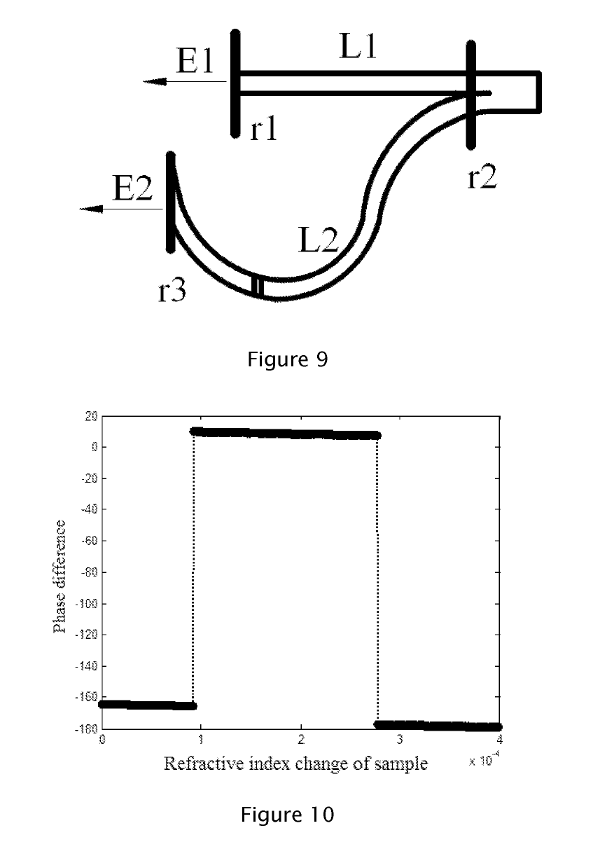

The following is a more detailed derivation. Assuming the output electric field of the two cavities are E1 and E2, respectively, as shown in FIG. 9. The propagation of the electric field in the two cavities can be written as

$$\{ \begin{matrix}{r}_{1} {E}_{1} {e}^{( i k + g ) L} {C}_{11} {r}_{2} + {r}_{3} {E}_{2} {e}^{( i k + g ) {L}^{′}} {C}_{21} {r}_{2} = {E}_{1} / {e}^{( i k + g ) L} \\ {r}_{2} {E}_{2} {e}^{( i k + g ) {L}^{′}} {C}_{22} {r}_{2} + {r}_{1} {E}_{1} {e}^{( i k + g ) L} {C}_{21} {r}_{2} = {E}_{2} / {e}^{( i k + g ) {L}^{′}}\end{matrix} \qquad ( 8 )$$

### That is

$$[ \begin{matrix}{r}_{1} {r}_{2} {C}_{11} {e}^{2 ( i k + g ) L} - 1 & {r}_{3} {r}_{2} {C}_{21} {e}^{( i k + g ) L} {e}^{( i k + g ) {L}^{′}} \\ {r}_{1} {r}_{2} {C}_{12} {e}^{( i k + g ) L} {e}^{( i k + g ) {L}^{′}} & {r}_{3} {r}_{2} {C}_{22} {e}^{2 ( i k + g ) {L}^{′}} - 1\end{matrix} ] [ \begin{matrix}{E}_{1} \\ {E}_{2}\end{matrix} ] = 0 \qquad ( 9 )$$

One can then obtain

$${E}_{2} = \frac{1 - {r}_{1} {r}_{2} {C}_{11} {e}^{2 ( i k + g ) L}}{{r}_{3} {r}_{2} {C}_{21} {e}^{( i k + g ) L} {e}^{( i k + g ) {L}^{′}}} {E}_{1} \qquad ( 10 )$$

As shown in FIG. 10, the phase difference between the output ports of the reference cavity FIG. 10 shows the calculated relative phase between the output fields E₂ and E₁ of the sensing cavity and the reference cavity at the reflecting mirrors 6 and 12. We can see it changes with the mode shift, which is a π-phase shift as mentioned previously.

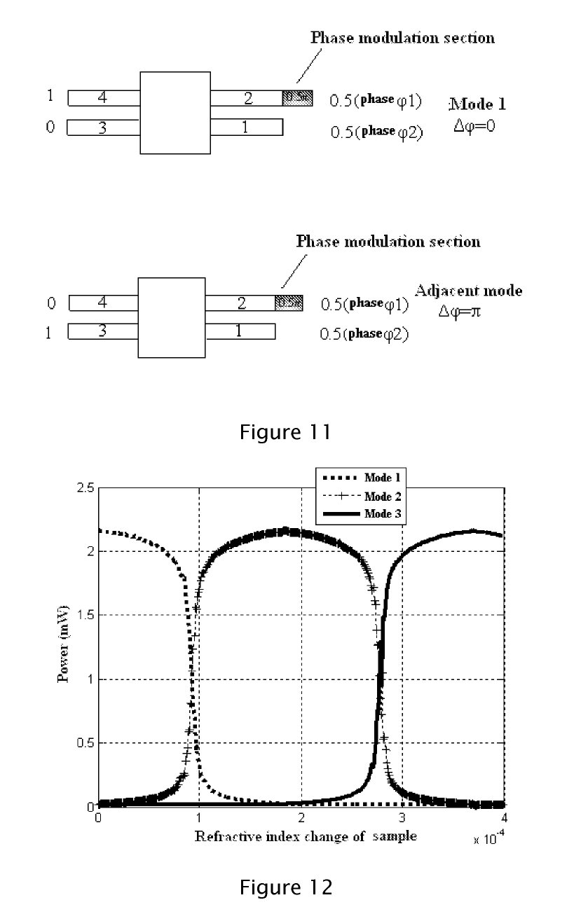

According to an implementation of the present invention, the outputs of the two cavities are coupled to the two output ports 3 and 4 through the input ports 1 and 2 of a 2×2 coupler 9. When the phase difference between port 1 and port 2 is 0, we apply an additional phase of π/2 on the phase adjustment section 5, as shown in FIG. 11(a). According to the property of a conventional 2×2 coupler (such as a multi-mode interference MMI coupler), all of the power will exit at port 4. When the phase difference between the adjacent modes at port 1 and 2 is π, as shown in FIG. 11(b), all of the power will exit at port 3. Therefore, the output power at port 3 and 4 will change as a function of the phase difference between port 1 and 2. Under the normal laser operation condition, more than one mode exists simultaneously in the laser cavity, as shown in FIG. 12. Each mode corresponds to a different phase difference and power at port 1 and 2. As a result, they exit at different output ports and result in the power ratio variation between port 3 and 4 when the refractive index of the analyte sample changes. For example, when the main mode of the laser exits from port 3 of the coupler 9, the main side mode will exit from port 4. By measuring the output power ratio between port 3 and 4, we can derive the sample index change, and consequently the concentration of the analyte sample.

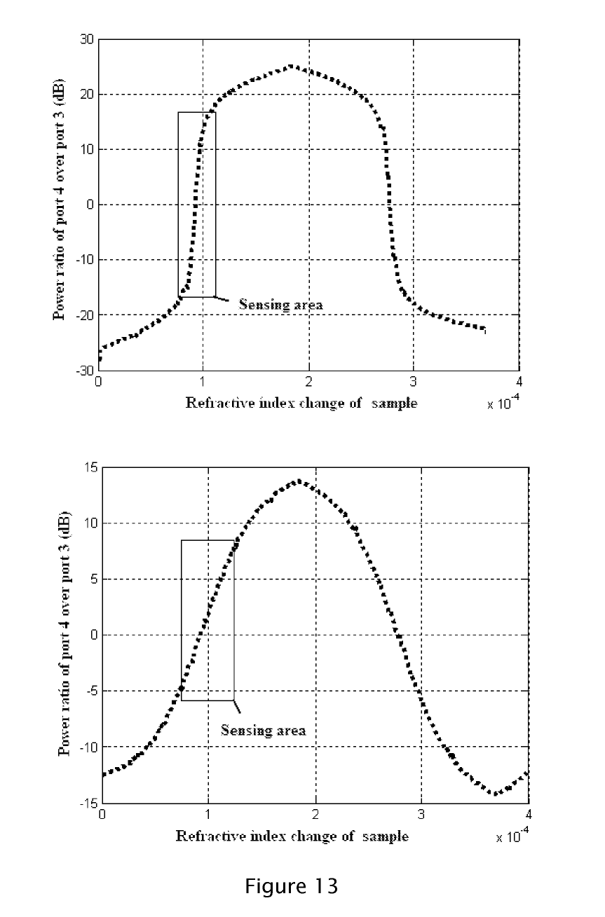

In the case of above example parameters, with the pumping current set to be 5 times of the threshold which is 59.75 mA, the variation of the output power ratio between port 3 and 4 is shown in FIG. 13(a) for sample refractive index change of 0˜4×10⁻⁴ RIU. Choosing the linear area as the operation range as marked in the figure, we can achieve a detection limit of 8.4×10⁻⁹ RIU.

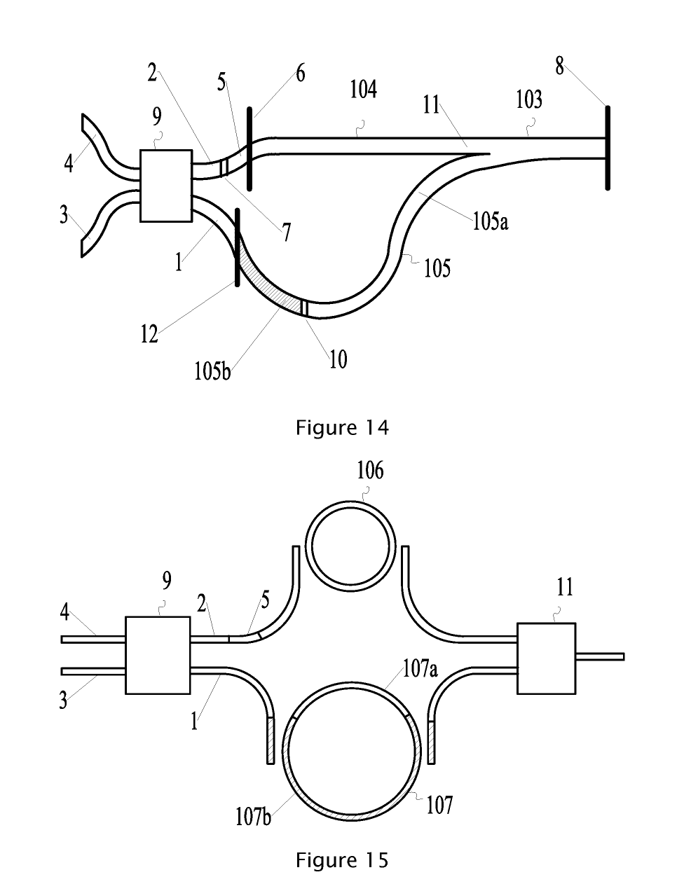

FIG. 14 is the second implementation of the present invention. The V-coupled cavity is replaced by a Y-coupled cavity in which the reference cavity and the sensing cavity share a common waveguide 103. 105a is the gain section, 105b is the sensing area. The resonant frequencies of the reference cavity 104 and the sensing cavity 105 meet the same condition as in the first implementation. We can rewrite the threshold condition as follows:

C₁C′₁r₁r₂e^{2(g+ik)L}+C₂C′₂r₃r₂e^{2(g′+ik′)L′}=1 (11)

where C₁, C₂, are the coupling coefficients from the common waveguide 103 into waveguide 104 and waveguide 105; C₁′, C₂′ are the coupling coefficients from waveguide 104 and waveguide 105 into the common waveguide 103; L and L′ are the waveguide length of the reference cavity and the sensing cavity, respectively. The other parameters are the same as in the first implementation. The phase relation can be rewritten as

$${E}_{2} = \frac{1 - {r}_{1} {r}_{2} {C}_{1} {C}_{1}^{′} {e}^{2 ( i k + g ) L}}{{r}_{3} {r}_{2} {C}_{2} {C}_{2}^{′} {e}^{( i k + g ) L} {e}^{( i k + g ) {L}^{′}}} {E}_{1} \qquad ( 12 )$$

By choosing an appropriate coupling coefficients, we can achieve an optimum sensitivity. FIG. 13(b) shows the power ratio between port 3 and 4. The pumping current is 5 times of the threshold current, and the refractive index change of the sample is 0˜4×10⁻⁴ RIU. Choosing the linear range as the sensing area (which is larger than the previous case), a detection limit of 3.85×10⁻⁸ RIU can be achieved.

FIG. 15 is the third implementation of the present invention. Different from the above implementations, the reference cavity 106 and the sensing cavity 107 are two ring resonators. 107a is the gain section, 107b is the sensing area. The radiuses of the rings are chosen to meet the condition of resonant frequencies as in the first implementation.

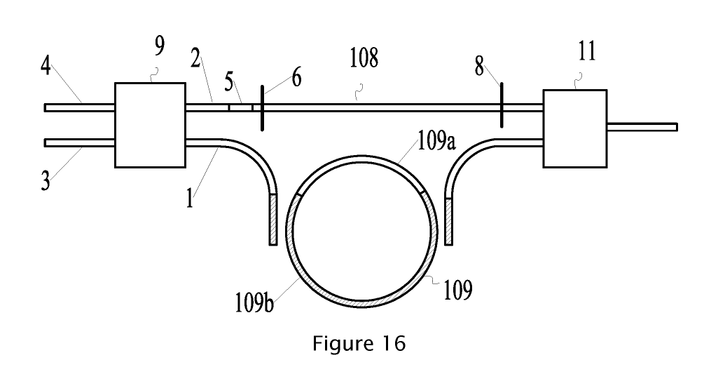

The invention also applies to the fourth implementation as shown in FIG. 16. One of the cavities (reference cavity108 and sensing cavity 109) is a Fabry Perot cavity, and the other is a ring resonator. 109a is the gain section and 109b is the sensing area.

The present inventions of integrated semiconductor laser based intra-cavity optical micro-fluidic biosensors have many advantages. Compared with general biological sensors, it monolithically integrates active and passive devices. No external light source is required, and the device is compact with a high degree of integration, suitable for mass production. Besides, the sensor does not require an external spectrometer, which greatly eases the operation of the sensor and reduces the cost.

The above implementations are used to illustrate the invention rather than limit the invention. Any modification and change made in the spirit of this invention and its claims shall fall into the scope of protection of this invention.

What is claimed is:

1. A semiconductor laser based intra-cavity optical micro-fluidic biosensor comprising:
a coupled-cavity semiconductor laser consisting of a reference cavity and a sensing cavity that are coupled to each other, a 2×2 coupler (9), and a phase adjustment section (5) on either input port of the 2×2 coupler,
said reference cavity and sensing cavity are coupled to each other through a coupler (11) to exchange energy, with the resonant frequencies of said reference cavity corresponding to a series of equally spaced operation frequencies, and the resonant frequency interval of said sensing cavity is different from that of said reference cavity so that at most only one resonant frequency of said sensing cavity coincides with one of the resonant frequencies of said reference cavity over the material gain window of the laser,
said sensing cavity contains a sensing section which is totally or partially in contact with an analyte,
whereas the outputs from the reference cavity and the sensing cavity are coupled through the input ports (1, 2) to the output ports (3, 4) of the 2×2 coupler (9), after passing through the phase adjustment section (5).

2. A semiconductor laser based intra-cavity optical micro-fluidic biosensor as defined in claim 1, wherein the resonant frequency interval of the sensing cavity is 0.4-0.6 times that of the reference cavity so that when the refractive index change of the analyte causes the lasing mode of the coupled cavity laser to switch from one mode to its adjacent mode, the phase difference of the laser output fields at the cleaved facets or etched trenches (6, 12) will experience a π-phase change.

3. A semiconductor laser based intra-cavity optical micro-fluidic biosensor as defined in claim 1, wherein the reference cavity and the sensing cavity are Fabry-Perot cavities formed by etched trenches as the partially reflecting mirrors on both sides, which constitute a V-shaped coupled cavity.

4. A semiconductor laser based intra-cavity optical micro-fluidic biosensor as defined in claim 1, wherein the reference cavity and the sensing cavity are Fabry-Perot cavities formed by etched trenches as the partially reflection mirrors on both sides with a common waveguide section, which constitute a Y-shaped coupled cavity.

5. A semiconductor laser based intra-cavity optical micro-fluidic biosensor as defined in claim 1, wherein the reference cavity and the sensing cavity are micro-ring resonators.

6. A semiconductor laser based intra-cavity optical micro-fluidic biosensor as defined in claim 1, wherein one of the reference cavity and the sensing cavity is a Fabry-Perot cavity and the other is a micro-ring resonator.
